(19) United States
(12) Patent Application Publication
(10) Pub. No.: US 2004/0235141 A1
(43) Pub. Date: Nov. 25, 2004

(54) Delivery system for heap bioleaching

(75) Inventor: Chris Andre Du Plessis, Randburg (ZA)

Correspondence Address: BRINKS HOFER GILSON & LIONE, P.O. BOX 10395, CHICAGO, IL, 60610, US

(73) Assignee: BHP Billiton SA Limited

(21) Appl. No.: 10/866,923

(22) Filed: Jun. 14, 2004

(30) Foreign Application Priority Data
Feb. 10, 2003 (WO) PCT/ZA03/00016
Feb. 14, 2002 (ZA) ZA 2002/0872

(51) Int. Cl. C12S 13/00

(52) U.S. Cl. 435/262; 435/266

(57) ABSTRACT

A method of heap leaching wherein a gaseous suspension which contains a microbial inoculum or nutrients is introduced into the heap.

The present invention is a continuation-in-part of and claims priority to PCT WO 03/068999 published in English on 21 Aug. 2003 and to South African application 2002/0872, the entire contents of both are incorporated herein by reference.

### BACKGROUND OF THE INVENTION

This invention relates generally to a heap bioleaching operation and more particularly is concerned with the delivery of a substance to a heap which is subjected to bioleaching.

The bioleaching of heaps of ores is a rapidly developing practice, particularly for the extraction of base metals from low grade sulphide ores. Through inoculation with bioleaching micro-organisms it is possible to initiate oxidation in ferrous- and sulphide-containing heaps which results in the liberation and solubilisation of base metals for subsequent solution recovery.

The effective extraction of metals in heap leaching operations depends, to a substantial extent, on the microbiological activity in the heaps. This activity is influenced by at least two factors, namely a uniform and effective distribution or inoculation of microbial cells capable of mineral leaching and an optimal nutrient availability to the microbial cells.

It is known to inoculate ore particles, substantially uniformly, by applying an inoculum to the particles prior to stacking the ore particles to form a heap, or by means of an agglomeration process. A more common method of inoculation is by irrigating a heap by recycling raffinate, a pregnant liquor solution or an intermediate liquor solution. The latter method is often resorted to due to the fact that a large volume of a suitable inoculum may not be available at the start of a heap leaching process, particularly during the stacking stage.

Nutrient compounds are required at certain optimal concentrations in order to facilitate microbial growth and activity. If these nutrients are added to an irrigation solution then they are likely to be precipitated from the solution as it migrates through a heap. This effectively removes the nutrients from the solution and the nutrients are then not available for microbial consumption.

The increased addition of nutrient compounds to an irrigation solution is undesirable due to the increased precipitation which would result from such addition. This, in turn, is detrimental to the chemical and physical factors which are desirable to facilitate the leaching process. If the nutrient compounds are precipitated then the microbial population in a heap is required to perform in a sub-nutrient environment and this results in sub-optimal bioleaching activity.

If a microbial inoculum is added to an irrigation solution, supplied for example to a top of a heap, then a sub-optimal distribution of the inoculum results due to the fact that the ore material through which the solution passes exerts attachment and filtration effects on the migrating microbial cells which give rise to a non-uniform microbial distribution within the heap.

### SUMMARY

The invention provides a method of delivering a substance to a heap which is subjected to bioleaching which includes the steps of producing a gaseous suspension of particles of the substance and introducing the suspension into the heap.

The substance may include one or more nutrients of any suitable composition, a microbial inoculum, or any appropriate mixture of the aforegoing.

The nutrients may be selected from phosphates, ammonia, potassium and, more generally, nutrients which are known in the art as being desirable for promoting microbial activity within a heap leaching process. The invention is not limited in any way in this regard.

The microbial inoculum which is introduced into the heap is chosen according to requirement taking into account at least the following factors: the metal or metals which are to be leached; the ambient conditions, including temperature of the heap; the availability of nutrients; and similar parameters.

The inoculum may contain vegetative microbial cells but, preferably, use is made of ultra-micro bacteria (UMB). UMB are microbes which have been cultured in a manner which causes a reduction in size. As a consequence of such size reduction the carrying capacity of the gaseous suspension is increased.

It falls within the scope of the invention for the particles in the gaseous suspension to be solid but, preferably, the particles are in liquid form i.e. droplets.

The particle size should be below 20 micrometers and preferably is in the range of 5 to 10 micrometers.

The particles may be produced from a liquid suspension which contains the substance i.e. the nutrient or nutrients and the microbial cells.

The gaseous suspension of particles may be introduced into the heap using any appropriate technique and the invention is not limited in this regard. Preferably the suspension is injected into an air stream which is used to aerate the heap.

The invention may include the step of increasing the relative humidity of the air stream. The relative humidity of the air stream may be increased to a level which, given the circumstances, is as high as possible.

### BRIEF DESCRIPTION OF THE DRAWINGS

The invention is further described by way of example with reference to the accompanying drawings in which:

FIG. 1 schematically illustrates an aerosol generator for use in the method of the invention,

FIG. 2 schematically illustrates a technique for introducing an aerosol, produced in the manner shown in FIG. 1, into a heap which is subjected to a bioleaching process, and

FIG. 3 illustrates one possible interaction of aerosol droplets with ore particles within a heap.

### DETAILED DESCRIPTION OF THE INVENTION

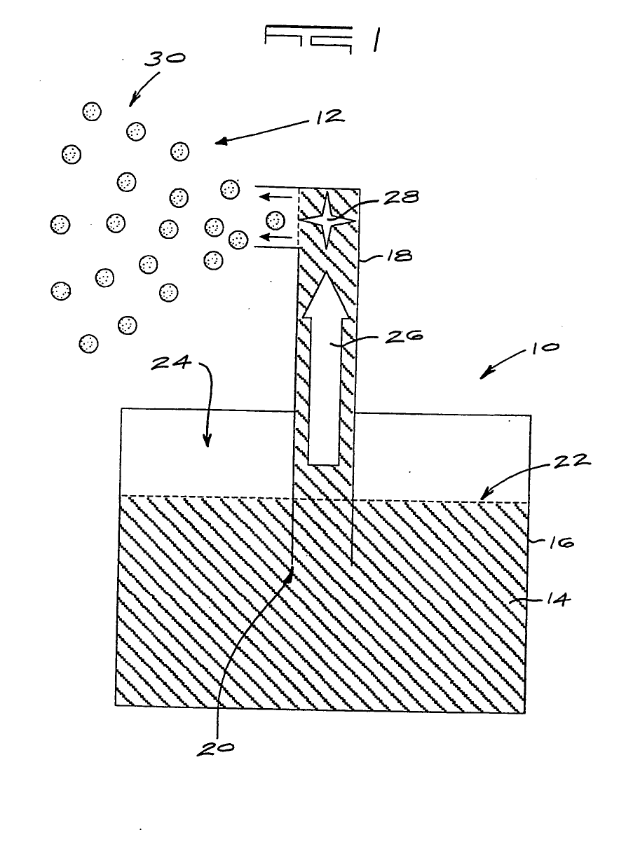

FIG. 1 of the accompanying drawings illustrates an aerosol generator 10 for use in the method of the invention. The function of the generator is to produce a gaseous suspension of fine liquid particles 12 from a liquid suspension 14 of a mixture of nutrients and microbial cells.

Without being limiting the nutrients in the suspension liquid 14 may include phosphates, ammonia and potassium.

The microbial cells in the suspension liquid 14 may be vegetative microbial cells but, as has been indicated, use is preferably made of ultra-micro bacteria (UMB). UMB are microbes which have been cultured in a manner which removes their polysaccharide cell envelopes, a process which often results in a reduction in size of the cells.

When a cell suspension is exposed to starvation conditions for a prolonged period changes occur in the cells in response to the unfavourable growth environment. The bacteria adapt through a series of starvation-survival responses with changes including a reduction in cell size, the use of cell storage products, a reduction in the endogenous respiration rate, a degradation of proteins, a reduction in RNA and the production of specific starvation proteins (Ref 1).

The starved cells are much smaller than the full-sized cells with significantly less glycocalyx (Ref 2; Ref 3). The small starved cells, which are usually termed ultra-micro bacteria, may be of the order of 0.3 micrometers or less in diameter. The UMB are dormant after starvation but they can be resuscitated with nutrient stimulation (Ref 3; Ref 4; Ref 5).

As a consequence of the size reduction and the reduced glycocalyx production the number of cells per unit volume which can be carried by each droplet is increased. It is also found that the maintenance requirements for the aerosol generator are reduced.

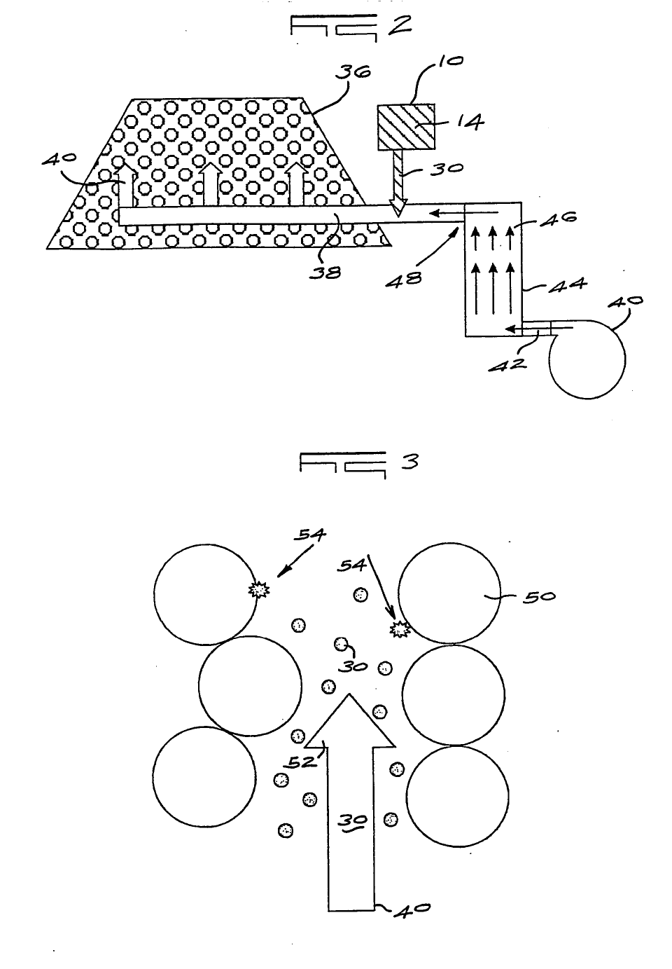

The aerosol generator 10 includes a vessel 16 which contains the liquid 14 and an outlet pipe 18 which has an inlet 20 below a level 22 of the liquid 14. An air space 24 inside the vessel, above the liquid level 22, is pressurised by any suitable device, not shown. This forces the liquid 14 upwardly through the pipe 18, as is indicated by means of an arrow 26, towards a baffle 28 which is in the nature of an atomising nozzle. As the liquid is forced through the baffle it is reduced to droplets in the range of 5 to 10 micrometers in diameter making up an aerosol 30. FIG. 2 illustrates a heap 36 of ore particles, of any appropriate kind, which is subjected to a bioleaching process. The bioleaching process is not explained in detail herein for, generally, it is known in the art. The current explanation is confined to the method of delivering the liquid 14, in droplet form, to the heap 36.

An air manifold 38 extends through a lower region of the heap and has at least one and desirably a plurality of outlet nozzles 40 at different locations inside the heap.

The aerosol generator 10, shown in FIG. 1, is connected to the manifold 38 at a location which is close to the heap 36. The manifold is fed by an air blower 40 which produces a constant stream 42 of pressurised air which is passed into a humidifier 44. The humidifier contains a counter-current water spray 46 which raises the relative humidity of the air to a level which is as high as possible under the circumstances. The humidified air leaves the humidifier through an exit 48 and the aerosol 30 is then injected into the air supply before the air passes into the manifold inside the heap.

The aerosol delivery system shown in FIG. 2 produces droplets which are sufficiently large to contain microbial cells but which are sufficiently small to be carried by the humidified air stream which is normally used for aerating the ore heap 36. By injecting the aerosol into the air supply manifold the microbial cells and the nutrients are delivered to exposed surfaces of ore particles within the heap. This is effected without the adsorption and filtration effects, which have been referred to hereinbefore, impacting on this delivery mode.

The aerosol droplets are delivered in a gaseous suspension (the humidified air stream) and consequently the migration path of the droplets within the heap 36 is significantly less impeded than what is the case with liquid migration i.e. when the heap is irrigated from above with an appropriate solution. The aerosol droplets also penetrate the heap more rapidly. As the droplets are not in contact with mineral surfaces while in transit the risk of precipitation (in the case of nutrients) and of adsorption (in the case of microbial cells) is reduced. Greater uniformity of cell distribution and nutrient supplementation can therefore be achieved and maintained within the heap.

FIG. 3 illustrates one possible way in which the liquid 14 is applied to ore particles 50 within the heap 36. A stream 52 of humidified air which contains droplets 30 is injected from one of the nozzles 40 (see FIG. 2) into the heap 36. The air percolates upwardly along a myriad of paths between the particles 50 together with the entrained droplets 30. The droplets break up upon colliding with ore particles 50, as is indicated by means of reference numerals 54, and the liquid in the droplets splutter-coats surfaces of the particles. This process results in an effective and wide-spread distribution of the inoculum and nutrients throughout the ore body within the heap. Clearly the degree of dispersion can be controlled, at least to a limited extent, by strategically positioning the air nozzles 40 of the manifold within the heap. To a considerable extent therefore it becomes possible to inoculate, or supply nutrients to, a heap, substantially uniformly, after the heap has been formed and, if necessary, on an on-going basis.

### References

Ref 1—Lappin-Scott, H. M. and Costerton, J. W. (1992). Ultramicrobacteria and their biotechnological applications. Curr Opinion Biotechnol 3, 283-285.

Ref 2—MacLeod, F. A., Lappin-Scott, H. M. and Costerton, J. W. (1988). Plugging of a model rock system by using starved bacteria. Appl Environ Microbiol 54 6), 1365-1372.

Ref 3—Lappin-Scott, H. M., Cusack, F., MacLeod, A. and Costerton, J. W. (1988b). Starvation and nutrient resuscitation of Klebsiella pneumoniae isolated from oil well waters. J Appl Bacteriol 64, 541-549.

Ref 4—Lappin-Scott, H. M., Cusack, F. and Costerton, J. W. (1988a). Nutrient resuscitation and growth of starved cells in sandstone cores: A novel approach of enhanced oil recovery. Appl Environ Microbiol 54 (6), 1373-1382.

Ref 5—Bryers, J. D. and Sanin, S. (1994). Resuscitation of starved ultramicrobacteria to improve in situ bioremediation. Annals New York Academy of Sciences. 745, 61-76.

What is claimed:

1. A method of delivering a substance to a heap which is subjected to bioleaching comprising producing a gaseous suspension of particles of the substance and introducing the suspension into the heap.

2. A method according to claim 1 wherein the substance includes at least one of one or more nutrients and a microbial inoculum.

3. A method according to claim 2 wherein the nutrients are selected from nutrients that promote microbial activity within a heap leaching process.

4. A method according to claim 3 wherein the nutrients include one or more of phosphates, ammonia, or potassium.

5. A method according to claim 2 wherein the microbial inoculum includes at least one of vegetative microbial cells and ultra-micro bacteria.

6. A method according to claim 1 wherein the particles are in liquid form.

7. A method according to claim 1 wherein the particles have a size less than about 20 micrometers.

8. A method according to claim 1 wherein the particles have a size in the range of about 5 to about 10 micrometers.

9. A method according to claim 1 wherein the particles are produced from a liquid suspension that contains the substance.

10. A method according to claim 1 wherein the suspension is injected into an air stream that is used to aerate the heap.

11. A method according to claim 10 that includes the step of increasing the relative humidity of the air stream.
